(19) United States
(12) Patent Application Publication
(10) Pub. No.: US 2015/0231771 A1
(43) Pub. Date: Aug. 20, 2015

(54) Power Tool

(71) Applicant: Hitachi Koki Co., Ltd., Tokyo (JP)

(72) Inventors: Hironori Sakai, Hitachinaka (JP); Naoki Tadokoro, Hitachinaka (JP)

(21) Appl. No.: 14/399,708

(22) PCT Filed: Jul. 19, 2013
(86) PCT No.: PCT/JP2013/004423

§ 371 Date: Nov. 7, 2014

(30) Foreign Application Priority Data
Sep. 28, 2012 (JP) 2012-216058

(51) Int. Cl. B25B 21/02

(52) U.S. Cl. CPC B25B 21/026

(57) ABSTRACT

A power tool includes a housing, a motor, a hammer, an anvil, a detecting unit, and a controller. The motor is accommodated in the housing. The hammer is configured to be rotated by the motor in a rotational direction about a rotational axis extending in an axial direction. The anvil is configured to be rotated upon being struck by the hammer. The detecting unit is configured to detect an impact generated in the rotational direction and the axial direction. The controller is configured to control the motor based on a detection result of the detecting unit.

### TECHNICAL FIELD

The invention relates to a power tool, and more particularly to a power tool that outputs rotational driving force.

### BACKGROUND ART

An impact wrench which is an example of a conventional power tool includes a motor, a spindle rotated by the motor, a hammer rotated by the spindle, and an anvil struck by the hammer. The anvil is provided with a detachable end bit so that a fastener such as a bolt is fastened to a workpiece by the end bit (For example, refer to Japanese Patent Application Publication No. 2009-72888).

### DISCLOSURE OF INVENTION

### Solution to Problem

However, in a fastening operation to a hard workpiece, because large reaction force is generated to the hammer upon striking the anvil, the hammer greatly moves back and impacts the spindle. This impact causes the hammer and the spindle to be temporarily locked with each other, and thus striking timings between the hammer and the anvil is deviated from normal striking timings therebetween. Thus, the striking force of the hammer is not transmitted sufficiently to the anvil, which causes a striking malfunction. Once such a striking malfunction occurs, the striking malfunction occurs successively, which causes a drop in fastening force of the impact wrench, vibrations, an increase in noise, and the like.

In the conventional impact wrench, it was difficult to accurately detect the above-described striking malfunction and to promptly resolve the striking malfunction that has occurred. In view of the foregoing, it is an object of the invention to provide a power tool capable of resolving the striking malfunction promptly.

In order to attain the above and other objects, the present invention provides a power tool. The power tool includes a housing, a motor, a hammer, an anvil, a detecting unit, and a controller. The motor is accommodated in the housing. The hammer is configured to be rotated by the motor in a rotational direction about a rotational axis extending in an axial direction. The anvil is configured to be rotated upon being struck by the hammer. The detecting unit is configured to detect an impact generated in the rotational direction and the axial direction. The controller is configured to control the motor based on a detection result of the detecting unit.

With this configuration, because the power tool includes the detecting unit capable of detecting the impact in the rotational direction and the axial direction, a striking state between the hammer and the anvil can be detected with high accuracy. Thus, a striking malfunction between the hammer and the anvil is detected accurately, and the controller controls the motor based on the detection result of the triaxial acceleration sensor, so that the striking malfunction can be resolved promptly.

According to another aspect, the present invention provides a power tool. The power tool includes a motor, a hammer, an anvil, and a detecting unit. The hammer is configured to be rotated in a rotational direction by the motor. The hammer is rotatable in the rotational direction and movable in an axial direction thereof. The anvil is configured to be rotated upon being struck by the hammer. The detecting unit is configured to detect a strike generated in the rotational direction in distinction from a strike generated in the axial direction.

With this configuration, the detecting unit can detect the strike in the rotational direction of the hammer, while distinguishing the strike in the rotational direction of the hammer from the strike in the axial direction thereof. Thus, detection can be performed while distinguishing a cam end impact from a pre-hit and an overshoot. This enables a detailed grasp of a state of the striking malfunction that has occurred in the power tool.

According to still another aspect, the present invention provides a power tool. The power tool includes a housing, a motor, a hammer, an anvil, a triaxial acceleration sensor, and a controller. The motor is accommodated in the housing. The hammer is configured to be rotated by the motor. The anvil is configured to be rotated upon being struck by the hammer. The triaxial acceleration sensor is configured to detect a strike between the hammer and the anvil. The controller is configured to control the motor based on a detection result of the triaxial acceleration sensor.

With this configuration, because the power tool includes the triaxial acceleration sensor, a striking state between the hammer and the anvil can be detected with high accuracy. Thus, a striking malfunction between the hammer and the anvil is detected accurately, and the controller controls the motor based on the detection result of the triaxial acceleration sensor, so that the striking malfunction can be resolved promptly.

### Advantageous Effects of Invention

The invention can provide a power tool capable of resolving the striking malfunction promptly.

### BRIEF DESCRIPTION OF DRAWINGS

FIG. 1 is a side cross-sectional view showing an overall structure of an impact wrench according to a first embodiment of the invention.

FIG. 2 is an exploded perspective view showing an impact mechanism of the impact wrench according to the first embodiment of the invention.

FIG. 3 is a perspective view showing the impact mechanism according to the first embodiment of the invention.

FIGS. 4A-4F are explanation views showing the operation of the impact mechanism according to the first embodiment of the invention.

FIG. 5 is a block diagram showing a motor of the impact wrench according to the first embodiment of the invention.

FIG. 6 is a flowchart showing an operation of the impact wrench according to the first embodiment of the invention.

FIGS. 7A-7D are graphs showing detection results of a triaxial acceleration sensor during the operation of the impact wrench according to the first embodiment of the invention.

FIG. 8 is a flowchart showing an operation of an impact wrench according to a second embodiment of the invention.

FIG. 9 is a flowchart showing an operation of an impact wrench according to a modification of the invention.

### BEST MODE FOR CARRYING OUT THE INVENTION

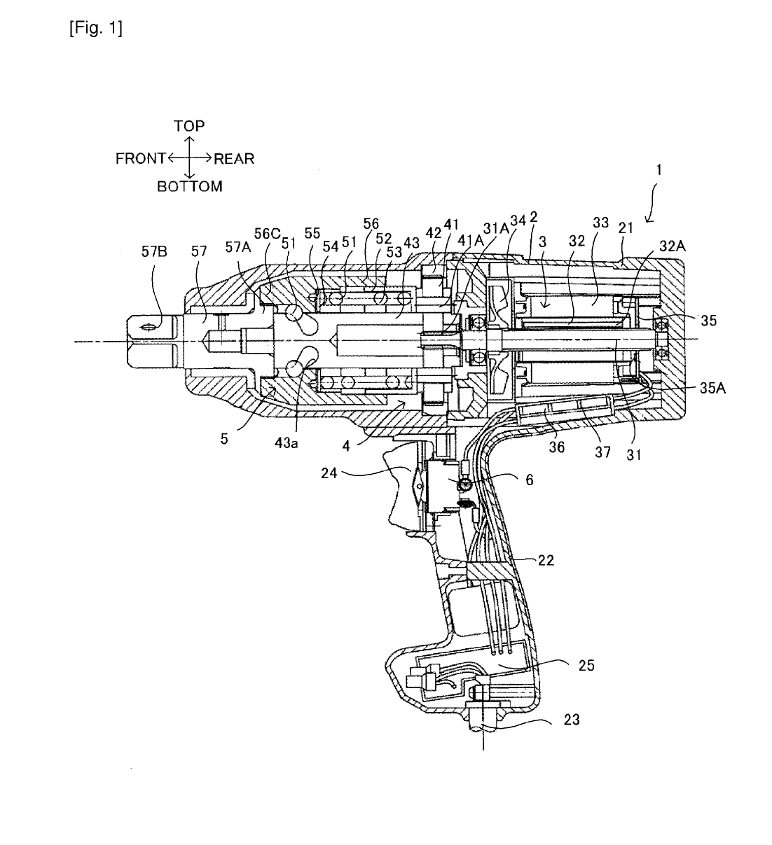

Hereinafter, an impact wrench 1 as an example of a power tool according to an embodiment of the invention will be described while referring to FIGS. 1 through 7D. The impact wrench 1 shown in FIG. 1 mainly includes a housing 2, a motor 3, a gear mechanism 4, and an impact mechanism 5. The housing 2 is made of resin, and constitutes the outer shell of the impact wrench 1. The housing 2 mainly has a substantially hollow-cylindrical body portion 21 and a handle portion 22 extending from the body portion 21.

As shown in FIG. 1, the motor 3 is disposed within the body portion 21 such that the axial direction of the motor 3 is coincident with the longitudinal direction of the body portion 21. Also, within the body portion 21, the gear mechanism 4 and the impact mechanism 5 are arranged toward one end side in the axial direction of the motor 3. In the following description, a direction from the motor 3 toward the gear mechanism 4 and the impact mechanism 5 is defined as a front side. A direction parallel to the axial direction of the motor 3 is defined as a front-rear direction. Further, an upper-lower direction is defined such that a lower side is a side in which the handle portion 22 extends from the body portion 21. Left and right sides as viewed from the rear side of the impact wrench 1 are defined as left and right sides.

The body portion 21 is formed with air inlet ports (not shown) for introducing external air into the body portion 21, and is formed with air outlet ports (not shown) for discharging air in the body portion 21 to the outside with a fan 34 described later.

The handle portion 22 extends downward from a substantially center position of the body portion 21 in the front-rear direction, and is formed integrally with the body portion 21. The handle portion 22 is provided with a switch mechanism 6 configured to selectively switch a power supply to the motor 3. Also, the handle portion 22 has a bottom end portion provided with a power cable 23 connectable to a commercial power source (not shown) and extending therefrom in the extending direction of the handle portion 22. The handle position 22 extends from the body portion 21 at a root position provided with a trigger 24 manipulated by an operator. The root portion is at the front side of the handle portion 22. The handle portion 22 has a lower portion accommodating a rectifier circuit 25 for converting an AC current supplied from the power cable 23 into a DC current.

As shown in FIG. 1, the motor 3 is a brushless motor mainly including: a rotor 32 having an output shaft 31 and a permanent magnet 32A; and a stator 33 disposed at a position in confrontation with the rotor 32. The motor 3 is disposed within the body portion 21 such that the axial direction of the output shaft 31 matches the front-rear direction. The output shaft 31 protrudes forward and rearward of the rotor 32, and is rotatably supported by the body portion 21 via bearings at the protruding portions. The fan 34 is provided at a position at which the output shaft 31 protrudes forward. The fan 34 is rotatable coaxially and integrally with the output shaft 31. The output shaft 31 has a front end portion provided with a pinion gear 31A rotating coaxially and integrally with the output shaft 31.

A board 35 having a plurality of Hall elements 35A is disposed at the rear side of the motor 3. The plurality of Hall elements 35A is provided at positions confronting the permanent magnet 32A in the front-rear direction. For example, three Hall elements 35A are provided at a predetermined interval such as 60 degrees in the circumferential direction of the output shaft 31.

A controller 37 having a triaxial acceleration sensor 36 is provided at an outer position of the motor 3 in a radial direction of the motor 3. The triaxial acceleration sensor 36 is adapted to detect accelerations in X, Y, Z-axis directions. In the present embodiment, acceleration in a thrust direction (axial direction) of the output shaft 31 is detected as acceleration in the Z-axis direction, and acceleration in a rotational direction (circumferential direction) of the output shaft 31 is detected as acceleration in the X, Y-axis directions. This enables detection of a shock of an impact operation by the impact mechanism 5 not only in the thrust direction but also in the rotational direction. The controller 37 is electrically connected to the board 35 and the rectifier circuit 25 via wiring. Detailed controls of the motor 3 will be described later. The triaxial acceleration sensor 36 is provided at a position adjacent to the motor 3 and on an imaginary extended line of the impact mechanism 5 in the axial direction, i.e., the triaxial acceleration sensor 36 is located at a position overlapped with the impact mechanism 5 as viewed from the axial direction. Hence, the triaxial acceleration sensor 36 can accurately detect a shock generated at the impact mechanism 5. The triaxial acceleration sensor 36 serves as detecting unit of the invention.

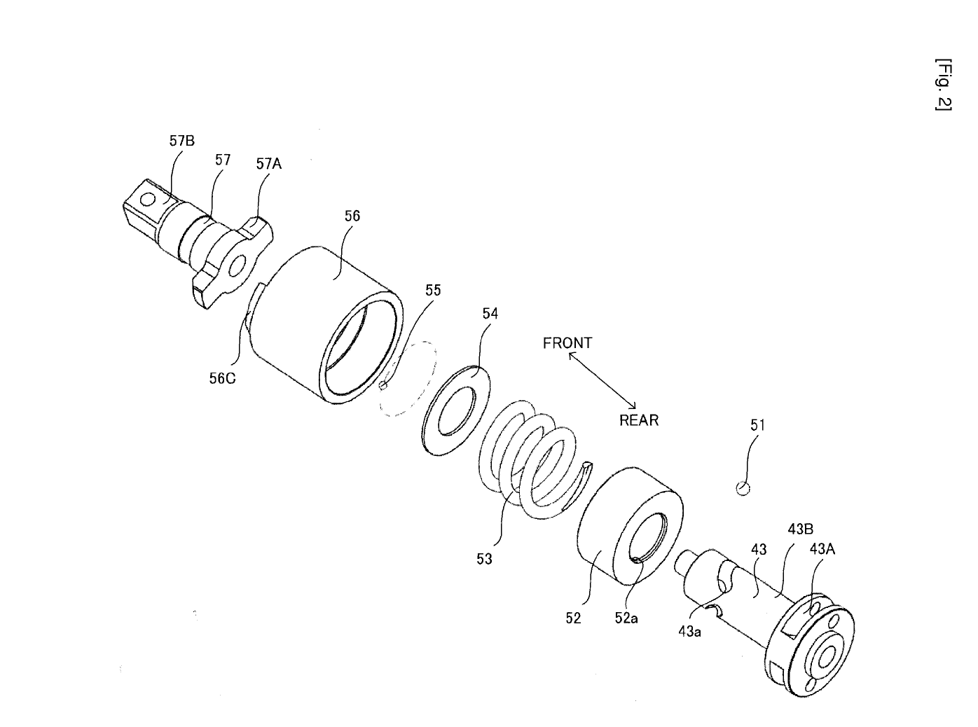

The gear mechanism 4 includes a pair of planetary gears 41 in meshing engagement with the pinion gear 31A, an outer gear 42 in meshing engagement with the planetary gears 41, and a spindle 43 for holding the planetary gears 41. The planetary gears 41 constitute a planetary gear mechanism having the pinion gear 31A as a sun gear. The planetary gears 41 decelerate rotations of the pinion gear 31A and transmit the decelerated rotations to the spindle 43. Each planetary gear 41 includes a rotational shaft 41A extending in the front-rear direction. The rotational shaft 41A is rotatably supported on the spindle 43. As shown in FIG. 2, the spindle 43 includes a gear supporting section 43A for supporting the planetary gears 41 and a shaft section 43B extending from the gear supporting section 43A. When the planetary gears 41 orbits the pinion gear 31A, the rotation causes the spindle 43 to rotate. In the following descriptions, an axial direction, a rotational direction, and a radial direction are directions with respect to the shaft section 43B.

The shaft section 43B extends in the front-rear direction. The shaft section 43B is formed with two substantially V-shaped grooves 43a opposing each other with respect to the rotational axis of the shaft section 43B. Each groove 43a is formed such that the opening of the V shape faces rearward. Each groove 43a receives a ball 51 described later such that the ball 51 is movable along the corresponding groove 43a. The substantially V-shaped groove 43a is formed by combining two sides extending in diagonally downward directions such that, when the spindle 43 is in a normal rotation, the ball 51 reciprocates only in one side and that, when the spindle 43 is in a reverse rotation, the ball 51 reciprocates only in the other side.

The impact mechanism 5 includes the ball 51, a stopper 52, a spring 53, a washer 54, a sphere 55, a hammer 56, and an anvil 57. The stopper 52 has substantially a hollow cylindrical shape. The stopper 52 is formed with a hole 52a penetrating the stopper 52 in the front-rear direction and through which the shaft section 43B is inserted. The stopper 52A has a front end surface contactable with the hammer 56 so as to prevent the hammer 56 from moving rearward more than a predetermined amount.

The spring 53 is a coil spring, and is fitted to the outside of the shaft section 43B. The spring 53A has a rear end portion in contact with the stopper 52, and a front end portion in contact with the washer 54. Thus, the spring 53 urges the hammer 56 in the forward direction via the washer 54. The washer 54 has substantially a disc shape, and is provided between the hammer 56 and the spring 53. The sphere 55 is provided between the washer 54 and the hammer 56.

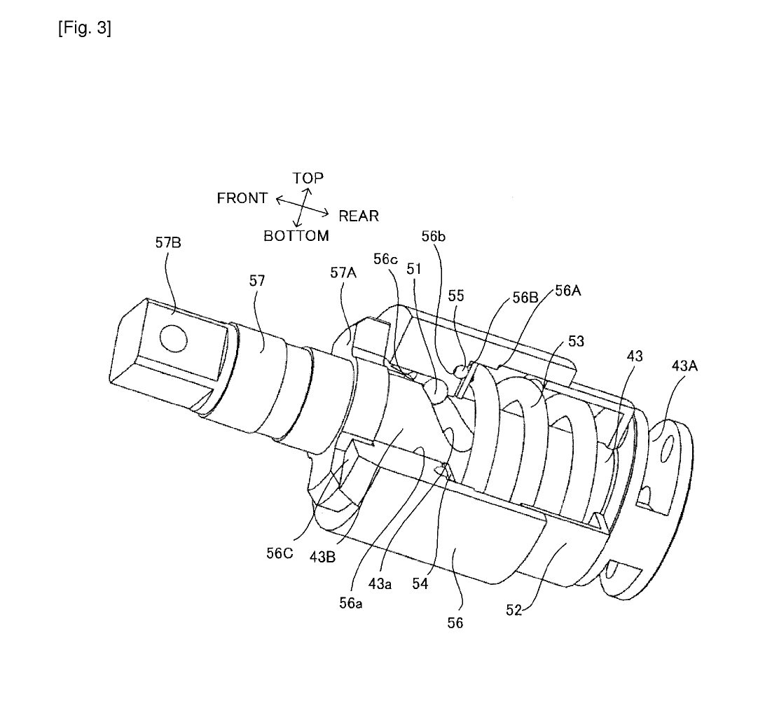

As shown in FIG. 3, the hammer 56 has substantially a hollow cylindrical shape. The hammer 56 is formed with a penetrating hole 56a penetrating the hammer 56 in the front-rear direction and through which the shaft section 43B is inserted. The penetrating hole 56a a step portion 56A protruding inward in the radial direction, permitting the step portion 56A to contact the front end surface of the stopper 52. A receiving portion 56B is formed at the front side of the step portion 56A. The receiving portion 56B protrudes farther inward in the radial direction than the step portion 56A, and receives the washer 54. The receiving portion 56B is formed with a concave portion 56b depressed in the forward direction. The sphere 55 is rotatably supported by the concave portion 56b, allowing the washer 54 and the spring 53 to rotate relative to the hammer 56.

Two groove portions 56c depressed inward in the radial direction are formed at the front side of the receiving portion 56B. The groove portions 56c are formed at positions confronting respective grooves 43a, so as to support the ball 51 together with the grooves 43a. With this configuration, the hammer 56 is held with respect to the spindle 43, and movement of the ball 51 along the groove 43a enables the hammer 56 to move in the front-rear direction and in the circumferential direction relative to the spindle 43. If the hammer 56 moves rearward more than the predetermined amount, the front end surface of the hammer 56 is brought into a position farther rearward than the grooves 43a, which causes the ball 51 to separate from the grooves 43a. However, a contact between the step portion 56A and the front end surface of the stopper 52 prevents excessive rearward movement of more than the predetermined amount by the hammer 56, which prevents separation of the ball 51. On the front end surface of the hammer 56, two engaging protrusions 56C protruding forward are provided at positions opposing each other with respect to the penetrating hole 56a.

The anvil 57 has substantially a cylindrical shape, and extends in the front-rear direction. The anvil 57 is provided with two engaged protrusions 57A protruding outward in the radial direction. The anvil 57A has a front end portion provided with a bit mounting section 57B for detachably mounting an end bit (not shown). The two engaged protrusions 57A are provided at positions opposing each other with respect to the rotational axis of the anvil 57.

When the spindle 43 is rotated by the motor 3, the ball 51, the hammer 56, the spring 53, and the stopper 52 rotate together with the spindle 43. This causes the engaging protrusions 56C to engage the engaged protrusions 57A, and the hammer 56 and the anvil 57 rotate together in order to perform a fastening operation of a bolt or the like. As the fastening operation proceeds, the load of the anvil 57 increases. When the load exceeds a predetermined value, the hammer 56 moves rearward against the urging force of the spring 53. At this time, the ball 51 moves rearward within the groove 43a. When the hammer 56 moves rearward by a distance more than a height of the engaging protrusion 56C in the front-rear direction, the engaging protrusion 56C gets over the engaged protrusion 57A that has engaged the engaging protrusion 56C. Because the rotational force of the spindle 43 is transmitted to the hammer 56 via the ball 51, the hammer 56 continues rotating and each engaging protrusion 56C strikes the engaged protrusion 57A opposite the engaged protrusion 57A that has previously engaged the engaging protrusion 56C. This causes the anvil 57 to rotate, and the rotational force is transmitted to the end bit (not shown) as a striking force. This striking operation generates a shock in the thrust direction and in the rotational direction that can be detected by the triaxial acceleration sensor 36.

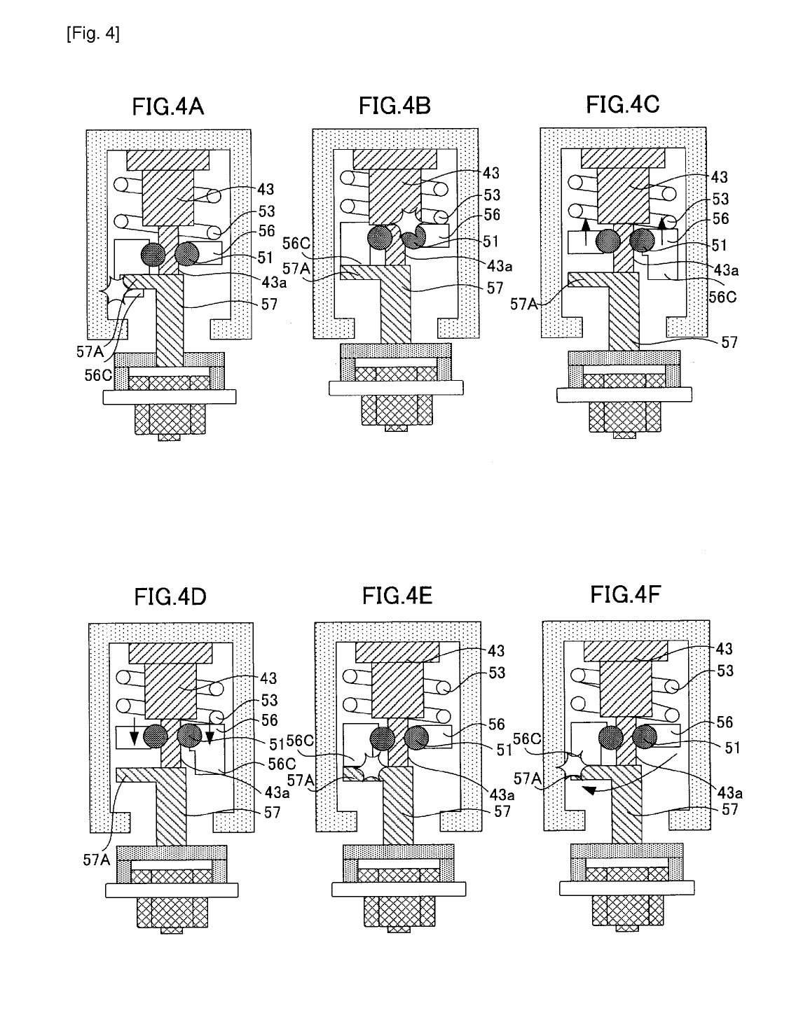

Reaction force is generated when the engaging protrusions 56C strike the engaged protrusions 57A. This reaction force causes the hammer 56 to move rearward against the urging force of the spring 53. At this time, the ball 51 moves rearward along the groove 43a (FIG. 4C). Because the hammer 56 rotates while moving rearward, the engaging protrusion 56C gets over the engaged protrusion 57A struck by the engaging protrusion 56C. The amount of rearward moving of the hammer 56 differs depending on hardness of a workpiece, the shape of the end bit, and the like. Then, the urging force of the spring 53 causes the hammer 56 to move forward again (FIG. 4D), and the ball 51 moves forward along the groove 43a. Then, when the ball 51 is located at the foremost position of the groove 43a (FIG. 3), each engaging protrusion 56C strikes the engaged protrusion 57A located at a position opposite the engaged protrusion 57A that has just been struck by the engaging protrusion 56C. A spring constant of the spring 53 and masses, shapes, etc. of the hammer 56 and the anvil 57 are so designed that a portion of the front end surface of the hammer 56 other than the engaging protrusions 56C contacts the rear surfaces of the engaged protrusions 57A and, at the same time, side surfaces of the engaging protrusions 56C in the rotational direction contact side surfaces of the engaged protrusions 57A in the rotational direction. A striking state at this time is referred to as an optimum striking state, which is shown in FIG. 4A. Thus, rotational energy of the hammer 56 can be transmitted to the anvil 57 efficiently.

During a fastening operation with the impact wrench 1, the end bit and a fastener such as a bolt sometimes engage and locked with each other, and cannot rotate relative to each other. In this case, because the hammer 56 strikes the anvil 57 while the anvil 57 is in a non-rotatable state, most part of the rotational energy of the hammer 56 returns to the hammer 56 as reaction force, and the hammer 56 moves rearward by a larger amount than in the optimum striking state. With this movement, the ball 51 is brought into contact with the rear end of the groove 43a, and a so-called cam end collision shown in FIG. 4B occurs. Due to the cam end collision, vibrations occurring in the impact wrench 1 increase, and the rotational energy is lost, which leads to a drop in the striking force.

Further, an occurrence of the cam end collision sometimes causes a deviation in striking timings between the hammer 56 and the anvil 57, and causes phenomena such as a pre-hit and an overshoot. FIG. 4E depicts a state of the pre-hit, and FIG. 4F depicts a state of the overshoot. The reaction force due to the cam end collision causes the hammer 56 to move forward at earlier timing than in the optimum striking state. And, the front end surface of the engaging protrusion 56C hits the rear surface of the engaged protrusion 57A, that is, a pre-hit occurs. Subsequently, the hammer 56 continues rotating, and the ball 51 is located at the foremost position in the groove 43a. Because the striking timing is deviated, the engaging protrusion 56C and the engaged protrusion 57A to be engaged therewith are spaced away from each other in the rotational direction when the ball 51 is located at the foremost position. Further rotation of the hammer 56 causes the ball 51 to move from one side to the other side each of the V-shaped groove 43a in which the ball 51 is currently reciprocating, which leads to an overshoot. Then, the overshoot causes the hammer 56 to slightly move rearward, and the engaging protrusion 56C strikes the engaged protrusion 57A in a state where the hammer 56 has moved rearward, i.e., the portion of the front end surface of the hammer 56 other than the engaging protrusions 56C is away from the rear surfaces of the engaged protrusions 57A due to the rearward movement of the hammer 56. Hence, the rotational energy of the hammer 56 is not transmitted to the anvil 57 sufficiently. In this way, once the striking timing is deviated, the pre-hit and the overshoot occur successively and the striking force drops. Thus, striking timing should be recovered to the optimum striking state promptly. Note that failures such as the cam end collision, the pre-hit, the overshoot, etc. occur under various conditions as well as the above-described case, depending on the workpiece and the end bit that is used. In the present embodiment, the triaxial acceleration sensor 36 having highly-precise detection of striking malfunction can accurately detect each of the pre-hit, the overshoot, and the cam end collision. By controlling the motor 3 based on the detection, the striking state can be recovered to the optimum striking state promptly. Detailed controls of the motor 3 and the like will be described later.

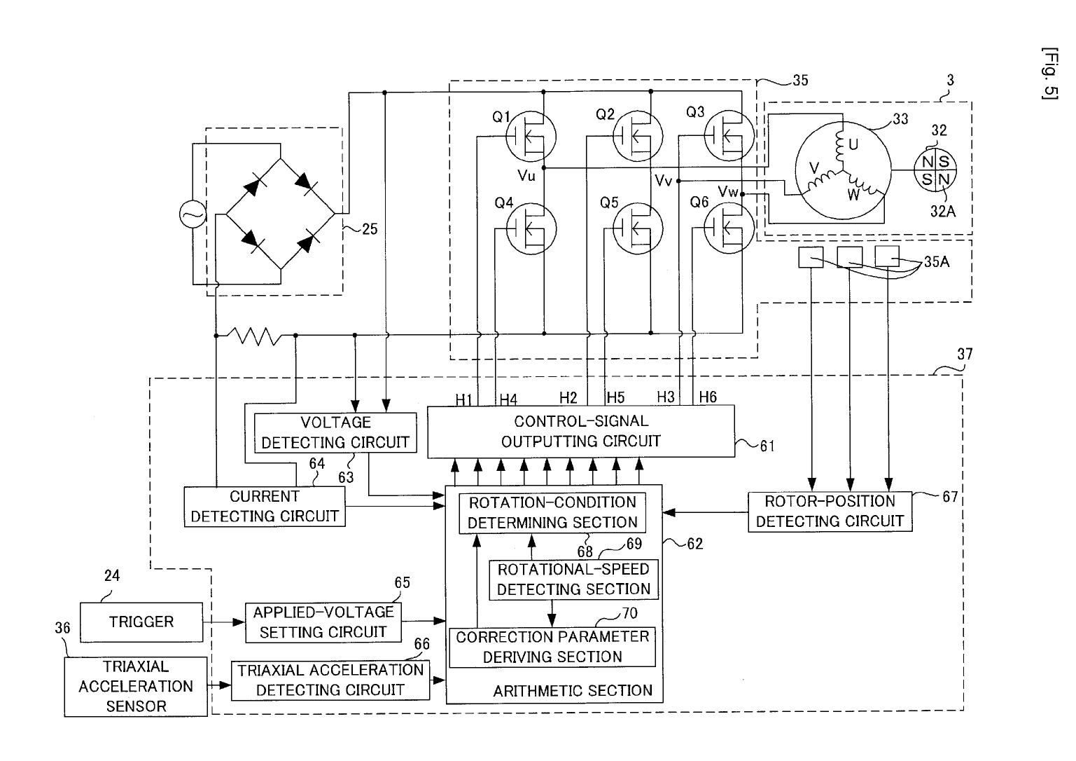

Next, the configuration of a control system for driving the motor 3 will be described while referring to FIG. 5. In the present embodiment, the motor 3 is a three-phase brushless DC motor. The rotor 32 of the brushless DC motor includes the permanent magnet 32A having a plurality of sets (two sets in the present embodiment) of N (north) pole and S (south) pole. The stator 33 includes three-phase stator windings U, V, and W in star connection. A direction and a time period for energizing the stator windings U, V, and W are controlled based on position detection signals from the Hall elements 35A disposed in confrontation with the permanent magnet 32A.

Electrical elements mounted on the board 35 include six switching elements Q1-Q6 such as FET in three-phase bridge connection. Each gate of the six switching elements Q1-Q6 in bridge connection is connected to a control-signal outputting circuit 61. Each drain or each source of the six switching elements Q1-Q6 is connected to the stator windings U, V, and W in star connection. With this configuration, the six switching elements Q1-Q6 perform switching operations with switching-element driving signals (driving signals such as H4, H5, H6 etc.) inputted from the control-signal outputting circuit 61, and converts a DC voltage that is full-wave rectified by the rectifier circuit 25 into three-phase (U-phase, V-phase, and W-phase) voltages Vu, Vv, and Vw, thereby supplying the stator windings U, V, and W with electric power.

Out of switching-element driving signals (three-phase signals), three negative-voltage switching elements Q4, Q5, and Q6 for driving each gate of the six switching elements Q1-Q6 are supplied with pulse-width modulation signals (PWM signals) H4, H5, and H6, respectively. Also, the controller 37 is provided with an arithmetic section 62 adapted to change a pulse width of the PWM signal (duty ratio) based on a detection signal of a manipulating amount (stroke) of the trigger 24, thereby adjusting an amount of electric power supplied to the motor 3. In this way, start/stop and the rotational speed of the motor 3 are controlled.

Here, a PWM signal is supplied to either the positive-voltage switching elements Q1-Q3 or the negative-voltage switching elements Q4-Q6 of the board 35. By switching the switching elements Q1-Q3 or the switching elements Q4-Q6 at high speed, electric power supplied from DC voltage of the rectifier circuit 25 to each of the stator windings U, V, and W is controlled. Note that, because the PWM signal is supplied to the negative-voltage switching elements Q4-Q6, by controlling the pulse width of the PWM signal, electric power supplied to each of the stator windings U, V, and W is adjusted so as to control the rotational speed of the motor 3.

The controller 37 includes the control-signal outputting circuit 61, the arithmetic section 62, a voltage detecting circuit 63, a current detecting circuit 64, an applied-voltage setting circuit 65, a triaxial acceleration detecting circuit 66, and a rotor-position detecting circuit 67. The arithmetic section 62 includes a rotation-condition determining section 68, a rotational-speed detecting section 69, a correction-parameter deriving section 70, a central processing unit (CPU) for outputting driving signals based on processing programs and data, a ROM for storing the processing programs and control data, and a RAM for temporarily storing data (these are not shown).

The arithmetic section 62 generates driving signals for alternately switching predetermined switching elements Q1-Q6 based on the output signal from the rotor-position detecting circuit 67, and outputs the control signals to the control-signal outputting circuit 61. With this operation, predetermined windings of the stator windings U, V, and W are alternately energized to rotate the rotor 32 in a set rotational direction. In this case, the driving signals applied to the negative-voltage switching elements Q4-Q6 are outputted as PWM modulation signals based on output control signals of the applied-voltage setting circuit 65. The voltage detecting circuit 63 and the current detecting circuit 64 detect a voltage value and a current value, respectively, that are supplied to the motor 3, and these values are fed back to the arithmetic section 62, thereby adjusting the voltage value and the current value so that the set driving power and current are obtained. Note that the PWM signals may be applied to the positive-voltage switching elements Q1-Q3.

The applied-voltage setting circuit 65 outputs control signals to the arithmetic section 62 based on an operation amount of the trigger 24. The triaxial acceleration detecting circuit 66 outputs each acceleration value in the thrust direction and in the rotational direction to the arithmetic section 62, based on signals from the triaxial acceleration sensor 36.

The rotation-condition determining section 68 determines whether striking between the hammer 56 and the anvil 57 is in the optimum striking state, based on the output signals from the triaxial acceleration detecting circuit 66. The rotational-speed detecting section 69 detects the rotational speed of the motor 3 based on the signals from the rotor-position detecting circuit 67. The correction-parameter deriving section 70 derives a correction parameter for adjusting the PWM duty for controlling the motor 3, based on the determination result of the rotation-condition determining section 68.

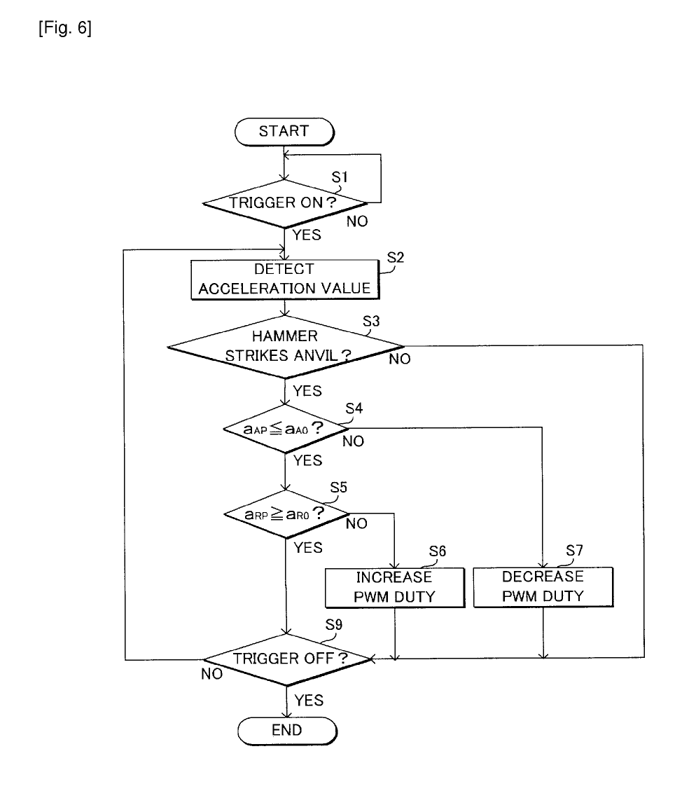

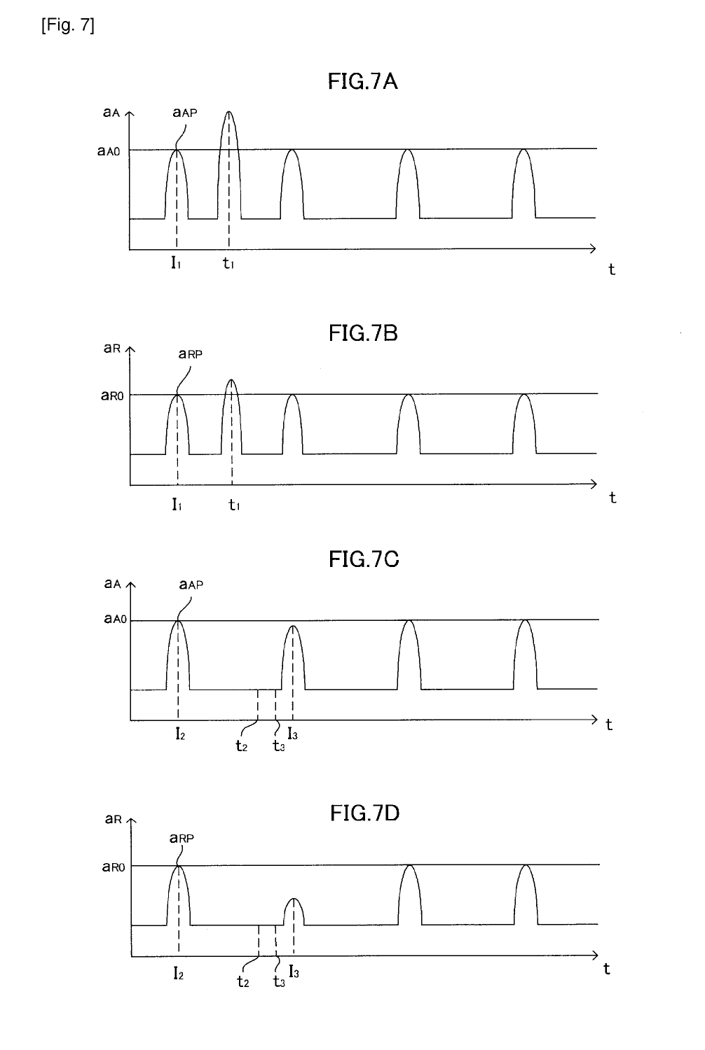

Next, the operations of the impact wrench 1 will be described while referring to FIGS. 6 through 7D. FIGS. 7A and 7B shows a state where the cam end collision is occurred at time t1 and FIGS. 7C and 7D shows a state where the pre-hit and the overshoot is occurred at times t2 and t3, respectively.

The flowchart of FIG. 6 starts when the power cable 23 is connected to a power source (not shown). The arithmetic section 62 determines whether the trigger 24 is manipulated (S1). If the trigger 24 is manipulated (S1: YES), the controller 37 detects acceleration values in the thrust direction and in the rotational direction, using the triaxial acceleration sensor 36 (S2).

The arithmetic section 62 determines whether the hammer 56 strikes the anvil 57, based on the signal from the triaxial acceleration detecting circuit 66 (S3). FIGS. 7A and 7C show the detection result, by the triaxial acceleration sensor 36, of thrust acceleration aA in the thrust direction. FIGS. 7B and 7D show the detection result, by the triaxial acceleration sensor 36, of rotational acceleration aR in the rotational direction. While the hammer 56 and the anvil 57 rotate together with engagement of the engaging protrusions 56C and the engaged protrusions 57A, the controller 37 determines that a striking operation is not performed because the thrust acceleration aA and the rotational acceleration aR are constant (S3: NO). If the load exceeds the predetermined value and the hammer 56 strikes the anvil 57 (S3: YES), the process advances to S4. Determination in S3, i.e., whether to occur the striking between the hammer 56 and the anvil 57, is determined, for example, based on an increase in the thrust acceleration aA which is acceleration in the thrust direction and based on an increase in the rotational acceleration aR which is acceleration in the rotational direction.

When occurring the striking, the rotation-condition determining section 68 determines whether a peak value aAP of the thrust acceleration aA is lower than or equal to a thrust target value aA0 (S4). The thrust acceleration aA in the optimum striking state is preliminarily set as the thrust target value aA0 and stored in the RAM. In FIG. 7A, at a first strike I1, the peak value aAP of the thrust acceleration aA is substantially the same as the thrust target value aA0, which is assumed to be the optimum striking state shown in FIG. 4A. If the thrust acceleration aA is lower than or equal to the thrust target value aA0 (S4: YES), the rotation-condition determining section 68 determines whether a peak value aRP of the rotational acceleration aR is larger than or equal to a rotational target value aR0 (S5). The rotational acceleration aR in the optimum striking state is preliminarily set as the rotational target value aR0 and stored in the RAM. In FIG. 7B, at the first strike I1, the peak value aRP of the rotational acceleration aR is substantially the same as the rotational target value aR0 (S5: YES), which is assumed to be the optimum striking state. Next, the controller 37 determines whether the operator releases the trigger 24 (S9). The processes in S2-S5 are repeated while the trigger 24 is manipulated. The thrust target value aA0 serves as an axial target value of the invention, and the rotational target value aR0 serves as a rotational target value of the invention.

In S2, the controller 37 again detects a value of the triaxial acceleration sensor 36. Because striking is already started (S3: YES), the process advances to S4. At time t1, the peak value aAP exceeds the thrust target value aA0 (S4: NO). This indicates that a shock in the thrust direction is large. More specifically, the hammer 56 has moved rearward due to the reaction force at the first strike I1 and thus hits the spindle 43, occurring the cam end collision (FIG. 4B). Then, the correction-parameter deriving section 70 calculates a correction parameter needed to adjust the peak value aAP to the thrust target value aA0, and the arithmetic section 62 reduces the PWM duty for controlling the motor 3 (S7). That is, a current value supplied to the motor 3 decreases, and the rotational speed drops. Thus, because the reaction force exerted on the hammer 56 decreases, the amount of rearward movement of the hammer 56 is reduced, thereby preventing the cam end collision. At the third strike and thereafter, the optimum striking state (FIG. 4A) is obtained at all the times (S4: YES). Although, the peak value aAP of the thrust acceleration aA is determined (S4) after the strike has been occurred (S3: YES), the controller 37 may constantly monitor the thrust acceleration aA regardless of the occurrence of the strike.

A case in which the peak value of the rotational acceleration aR becomes lower than the rotational target value aR0 (S5: NO) will be described while referring to FIGS. 7C and 7D. A first strike I2 is in the optimum striking state. However, at a second strike I3, the peak value aRP of the rotational acceleration aR is considerably lower than the rotational target value aR0. This is caused by occurrences of the pre-hit and the overshoot. Specifically, subsequent to the first strike I2, the hammer 56 moves rearward (FIG. 4C) and moves forward (FIG. 4D). However, because the amount of rearward movement at this time is smaller than the amount in the optimum striking state, striking timing is deviated and a pre-hit occurs at time t2 (FIG. 4E). Because a shock generated in the pre-hit is small, the triaxial acceleration sensor 36 does not detect the pre-hit. Then, subsequent to the pre-hit, at time t3 an overshoot occurs and the hammer 56 strikes the anvil 57 as the second strike I3 while being moved rearward slightly due to the overshoot (FIG. 4F). Then, because the rotational energy of the hammer 56 is not transmitted sufficiently to the anvil 57, the peak value aRP of the rotational acceleration aR is smaller than that of the optimum striking state. As shown in FIG. 7C, the peak value aAP of the thrust acceleration aA at the second strike I3 is slightly smaller than the thrust target value aA0. However, the peak value aRP of the rotational acceleration aR at the second strike I3 is more remarkably smaller than the rotational target value aR0. A mono-axial (single axis) acceleration sensor or a biaxial acceleration sensor can only detect the thrust acceleration aA. Hence, although the mono-axial acceleration sensor can detect a cam end collision, the mono-axial acceleration sensor cannot accurately detect a pre-hit or an overshoot in which the rotational acceleration aR drops significantly. In the present embodiment, the triaxial acceleration sensor 36 can detect not only the thrust acceleration aA but also the rotational acceleration aR, thereby reliably detecting an occurrence of the pre-hit and overshoot.

If the rotation-condition determining section 68 determines that the peak value aRP of the rotational acceleration aR is smaller than the rotational target value aR0 (S5: NO), the correction-parameter deriving section 70 calculates a correction parameter needed to adjust the peak value aRP of the rotational acceleration aR to the rotational target value aR0, and the arithmetic section 62 increases the PWM duty for controlling the motor 3 (S6). That is, a current value supplied to the motor 3 increases, and the rotational speed increases. Thus, because the reaction force exerted on the hammer 56 increases, the amount of rearward movement of the hammer 56 increases, thereby preventing the pre-hit and the overshoot. At the third strike and thereafter, the optimum striking state (FIG. 4A) is obtained at all the times (S4: YES, S5: YES).

With this configuration, because the impact wrench 1 includes the triaxial acceleration sensor 36, a striking state between the hammer 56 and the anvil 57 can be detected with high accuracy. Thus, a striking malfunction between the hammer 56 and the anvil 57 is detected accurately, and the controller 37 controls the motor 3 based on the detection result of the triaxial acceleration sensor 36, so that the striking malfunction can be resolved promptly.

With this configuration, the triaxial acceleration sensor 36 can detect a shock of the hammer 56 in the rotational direction and a shock of the hammer 56 in the thrust direction. Thus, the striking malfunction between the hammer 56 and the anvil 57 can be detected more accurately.

If the hammer 56 strikes the anvil 57 out of the optimum striking state, the reaction force due to striking decreases and a shock in the rotational direction becomes smaller than the rotational target value aR0 (pre-hit, overshoot). In this case, the controller 37 raises a current (PWM duty) supplied to the motor 3 in order to cause the hammer 56 to strike the anvil 57 in the optimum striking state. This can suppress a drop in the striking force at a minimum level, and can resolve the striking malfunction promptly.

If the reaction force exerted on the hammer 56 is relatively large when the hammer 56 strikes the anvil 57, the amount of rearward movement of the hammer 56 becomes large so that the spindle 43 and the hammer 56 hit each other and a shock in the thrust direction becomes larger than the thrust target value aA0. Also, because the spindle 43 and the hammer 56 hit each other, the rotational energy from the motor 3 is lost, and striking force drops (cam end collision). In this case, in order to suppress reaction force exerted on the hammer 56 upon striking the anvil 57, the controller 37 reduces a current (PWM duty) supplied to the motor 3. This can suppress a drop in the striking force at a minimum level, and can resolve the striking malfunction promptly.

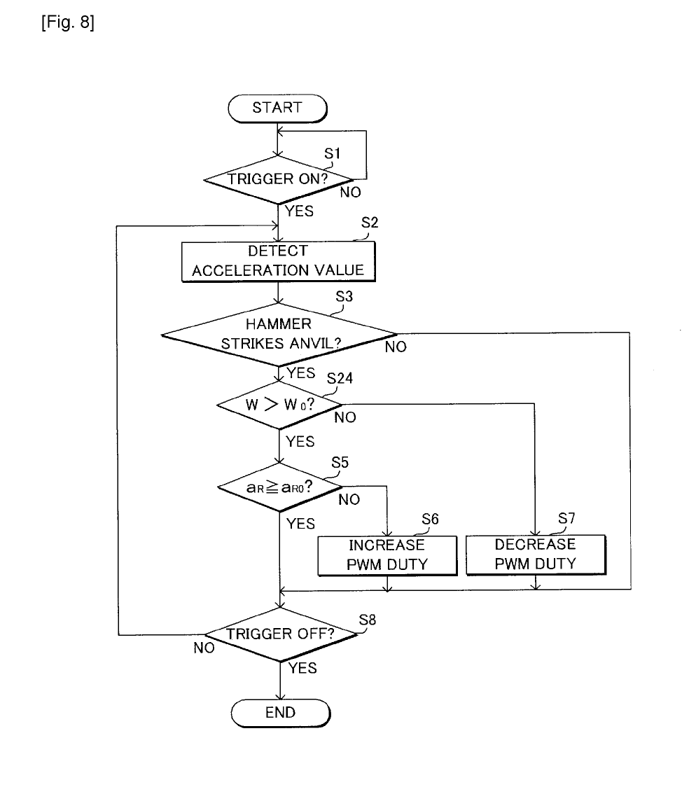

Hereinafter, a second embodiment of the invention will be described while referring to the flowchart in FIG. 8, wherein like parts and components are designated by the same reference numerals to avoid duplicating description. In the first embodiment, a cam end collision is detected by the triaxial acceleration sensor 36. In the second embodiment, the cam end collision is detected based on the rotational speed of the motor 3.

In S3, if a strike is detected (S3: YES), the rotation-condition determining section 68 determines whether a rotational speed w of the motor 3 detected by the rotational-speed detecting section 69 is larger than a target rotational speed w0 which is set preliminarily and stored in the RAM (S24). Rotations of the motor 3 are transmitted to the spindle 43 via the planetary gears 41 etc., and the spindle 43 rotates at a constant rotational speed. When the cam end collision occurs, the ball 51 hits the rear end portion of the groove 43a to cause the hammer 56 and the anvil 57 to be temporarily locked to each other, which leads to a drop in the rotational speed of the spindle 43. With the drop in the rotational speed of the spindle 43, the rotational speed of the motor 3 also drops. That is, the cam end collision can be detected based on the drop in the rotational speed of the motor 3. If the rotational speed w of the motor 3 is smaller than or equal to the preset target rotational speed w0 (S24: NO), the controller 37 determines that the cam end collision occurs and advances to S7. On the other hand, if the rotational speed w of the motor 3 is larger than the preset target rotational speed w0 (S24: YES), the controller 37 determines that the cam end collision does not occur and the process advances to S5.

With this configuration, the controller 37 controls the motor 3 based on the detection results of the rotational-speed detecting section 69 and the triaxial acceleration sensor 36. Hence, the cam end collision can be detected reliably.

If the rotational speed of the motor 3 drops below the rotational target value aR0, the controller 37 determines that the hammer 56 and the spindle 43 are temporarily locked with each other, and reduces a current (PWM duty) supplied to the motor 3. This can suppress a drop in the striking force at a minimum level, and can resolve the striking malfunction promptly.

While the impact wrench of the invention has been described in detail with reference to the above aspects thereof, it would be apparent to those skilled in the art that various changes and modifications may be made therein without departing from the scope of the claims.

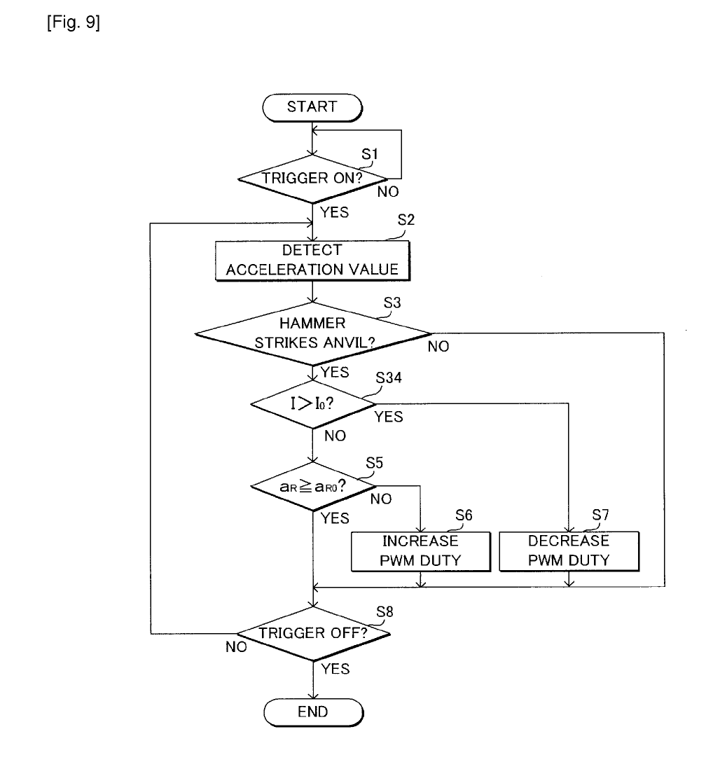

In the second embodiment, the cam end collision is detected based on the rotational speed w of the motor 3. However, the cam end collision may be detected based on a current value of the motor 3. In this case, because an occurrence of the cam end collision temporarily increases a load on the spindle 43 due to a temporary lock state between the hammer 56 and the spindle 43, the current value I of the motor 3 increases. If the current value I of the motor 3 exceeds a current target value I0 which is set preliminarily and stored in the RAM, the controller 37 determines that the cam end collision occurs and reduces the PWM duty for controlling the motor 3. As shown in FIG. 9, the controller 37 determines whether the current value I is larger than the current target value I0 (S34). If so (S34: YES), the controller 37 determines that the cam end collision is occurred and the process advances to S7. If not (S34: NO), the process advances to S5. Although, the current value I is determined (S34) after the strike has been occurred (S3: YES), the controller 37 may constantly monitor the current value I regardless of the strike.

In the above-described embodiment, a shock in the rotational direction and in the thrust direction is detected by the single triaxial acceleration sensor 36. However, a shock in the rotational direction and in the thrust direction may be detected by combining two acceleration sensors. With this configuration, the cam end collision can be detected by one acceleration sensor, and the pre-hit and overshoot can be detected by another acceleration sensor.

In the above-described embodiment, an electric motor is used as the motor 3, but an air motor may be used.

### REFERENCE SIGNS LIST

1 Impact wrench
2 Housing
3 Motor
4 Gear mechanism
5 Impact mechanism
24 Trigger
25 Rectifier circuit
36 Triaxial acceleration sensor
37 Controller
56 Hammer
57 Anvil
62 Arithmetic section
66 Triaxial acceleration detecting circuit
67 Rotor-position detecting circuit
68 Rotation-condition determining section
69 Rotational-speed detecting section
70 Correction-parameter deriving section
aA0 Thrust target value
aR0 Rotational target value

1. A power tool comprising:
a housing;
a motor accommodated in the housing;
a hammer configured to be rotated by the motor in a rotational direction about a rotational axis extending in an axial direction;
an anvil configured to be rotated upon being struck by the hammer;
a detecting unit configured to detect an impact generated in the rotational direction and the axial direction; and
a controller configured to control the motor based on a detection result of the detecting unit.

2. The power tool according to claim 1, wherein the detecting unit is a triaxial acceleration sensor.

3. The power tool according to claim 1, wherein the detecting unit includes a first detecting unit configured to detect an impact generated in the rotational direction and a second detecting unit configured to detect an impact generated in the axial direction.

4. The power tool according to claim 1, wherein the controller increases a current supplied to the motor if an impact in the rotational direction detected by the detecting unit is lower than a rotational target value.

5. The power tool according to claim 1, wherein the controller decreases a current supplied to the motor if an impact in the axial direction detected by the detecting unit is higher than an axial target value.

6. The power tool according to claim 1, further comprising a rotation detecting unit configured to detect a rotational speed of the motor,
wherein the controller is configured to control the motor based on detection results of the detecting unit and the rotation detecting unit.

7. The power tool according to claim 6, wherein the controller decreases a current supplied to the motor if a rotational speed detected by the rotational detecting unit is lower than a rotational target value,
wherein the controller increases the current supplied to the motor if an impact in the rotational direction detected by the detecting unit is lower than a rotational target value.

8. The power tool according to claim 1, further comprising a current detecting unit configured to detect a current supplied to the motor,
wherein the controller is configured to control the motor based on detection results of the detecting unit and the current detecting unit.

9. The power tool according to claim 8, wherein the controller decreases a current supplied to the motor if a current detected by the current detecting unit is lower than a current target value,
wherein the controller increases the current supplied to the motor if an impact in the rotational direction detected by the detecting unit is lower than a rotational target value.

10. A power tool comprising:
a motor;
a hammer configured to be rotated in a rotational direction by the motor, the hammer being rotatable in the rotational direction and movable in an axial direction thereof;
an anvil configured to be rotated upon being struck by the hammer; and
a detecting unit configured to detect an impact generated in the rotational direction in distinction from an impact generated in the axial direction.

11. The power tool according to claim 10, wherein the detecting unit is configured to detect the impact generated in the axial direction in distinction from the impact generated in the rotational direction.

12. A power tool comprising:
a housing;
a motor accommodated in the housing;
a hammer configured to be rotated by the motor;
an anvil configured to be rotated upon being struck by the hammer;
a triaxial acceleration sensor configured to detect an impact between the hammer and the anvil; and
a controller configured to control the motor based on a detection result of the triaxial acceleration sensor.
